(19) United States
(12) Patent Application Publication
(10) Pub. No.: US 2009/0325134 A1
(43) Pub. Date: Dec. 31, 2009

(54) METHOD AND SYSTEM FOR CONSTRUCTING AND DECONSTRUCTING WRITTEN TEXT

(76) Inventor: Stacy Harris, Chicago, IL (US)

Correspondence Address: WOLF GREENFIELD & SACKS, P.C., 600 ATLANTIC AVENUE, BOSTON, MA, 02210-2206, US

(21) Appl. No.: 12/555,197

(22) Filed: Sep. 8, 2009

Related U.S. Application Data
(63) Continuation of application No. PCT/US2008/003025, filed on Mar. 7, 2008.
(60) Provisional application No. 60/905,769, filed on Mar. 8, 2007.

(51) Int. Cl. G09B 17/00; A63F 1/00

(52) U.S. Cl. 434/178; 273/299

(57) ABSTRACT

A learning methodology that uses a consistent, constructive, integrative, content-within-context structural approach that involves visual, auditory, tactile, experiential, associative and/or spatial modalities. A contextual structure is used to help analyze text where topic, topic information, theme, and main idea are components of content statements of the contextual structure, and supporting details are content details of the contextual structure. Text portions and their relationships may be shown graphically with a structural framework based on the contextual structure. Active, consistent highlighting or other techniques are used to uniquely identify text portions as related to one or more components of the contextual structure.

### CROSS REFERENCE TO RELATED APPLICATIONS

This application is a continuation of International Patent Application Serial No. PCT/US2008/003025, filed Mar. 7, 2008. Application PCT/US2008/003025 claims priority under 35 U.S.C. § 119(e) to U.S. Provisional Application Ser. No. 60/905,769, entitled “METHOD AND SYSTEM FOR CONSTRUCTING AND DECONSTRUCTING WRITTEN TEXT” filed on Mar. 8, 2007, which is herein incorporated by reference in its entirety.

### BACKGROUND

For many students, both children and adults, learning to read and write effectively can be a difficult process. Many techniques and systems currently exist to help such students and have varying degrees of success. Many such techniques and systems do not have universal appeal since they work well with some students, but not necessarily with others.

### SUMMARY OF INVENTION

Some aspects of the invention provide a system for learning to read and/or write that employs several modes of learning, in some cases integrating the various learning modes, to more effectively provide instruction to students. For example, some students learn abstract concepts by touching and feeling objects, whether those objects have a real connection to the concepts or not. Others learn best by verbalizing; others through visual experience. Aspects of the invention employ modes such as visual, auditory, tactile, experiential, associative and/or spatial, to help convey information to the student. As a result, aspects of the invention may have a more universal appeal to a wider range of students.

Aspects of the invention provide a learning methodology that uses a consistent, constructive, integrative, content-within-context structural approach that involves visual, auditory, tactile, experiential, associative and/or spatial modalities. Aspects of the invention can be applied to history, science, and/or literature texts for the purposes of previewing, reading, organizing, and/or writing text for effective analysis, synthesis, application, and transfer of information.

In one aspect of the invention, a contextual structure is used to help analyze text where topic, topic information, theme, and main idea are components of content statements of the contextual structure, and supporting details are content details of the contextual structure. Active, consistent highlighting or other techniques for uniquely identifying text portions as related to one or more components of the contextual structure may involve color-coding text portions (e.g., words and/or phrases are highlighted with a color associated with a particular contextual structure component), underlining, marking with appropriate symbols (such as “T” for topic, “TH” for theme, and so on), placing text on separate pieces of paper or other objects along with related organization, or any other suitable approach. Consistent identification of text portions as being associated with components in the contextual structure can help students internalize and recognize the relationship between the text portions. Text portions and their relationships may be shown graphically using a structural framework based on the contextual structure, e.g., in the form of an outline, flowchart, active highlighting or other unique identification of text portions as related to contextual structure components. Thus, the structural framework can help students visualize how information develops as well as connects within the text. Furthermore, the structural framework may be used to stress how writing structure should develop in an angular logical flow. The structural framework may also facilitate the student's learning how to outline.

Aspects of the invention require the student to master rote knowledge of all definitions for the contextual structural components, all marking techniques, all annotation methods and all symbols (e.g., for associating text portions with components of the contextual structure). This is “automatic” knowledge—the student need not think about these features. With automatic knowledge mastered, the student can employ “procedural” knowledge, e.g., how to find contextual structure components, how to analyze and then synthesize an auditory or visual presentation, how to apply analysis and synthesis of the contextual structure to curricula material, how to represent information in flowcharts or outlines to represent knowledge and understanding, etc.

In another aspect of the invention, a complete main idea can be conceptualized as a text portion that incorporates both thematic keywords and relevant topic keywords. Thus, identification of a main idea can be facilitated through the identification (e.g., color-coding or other unique marking) of thematic keywords and topic keywords in text. Text portions (such as sentences) that relate to a main idea may be identified as those portions including both thematic- and topic-related keywords.

In another aspect of the invention, a complete main idea can be conceptualized as a text portion that contains topic and action keywords. Action keywords may identify what the topic is doing, and thus relate the purpose of the topic information. Thus, identification of topic keywords and action keywords in a text portion can lead to the identification of a related main idea and its purpose.

In another aspect of the invention, topic keywords may be used to find relevant content details within an overall context. For example, topic key words may be initially identified (e.g., highlighted with an appropriate color or otherwise marked), and then “pulled down” into other portions of the text to guide the identification of supporting details. “Pulling down” of topic keywords may be done in a physical and/or visual way (e.g., drawing arrows from one topic key word location to another subsequent location for the keyword in the text) to reinforce connections between text portions.

In another aspect of the invention, relevant factual detail information, e.g., information that answers questions of what, who, when, where, how and why, may be found within the supporting content details of overall context. In some cases, the order of presentation of the questions may replicate the order of information in the written text. Question words may be used effectively (e.g., by the reader repeatedly asking the questions during reading) to identify the relevant factual detail information. These question words and answers to them may also be identified with active consistent highlighting or other unique identification techniques that involve color-coding text portions (e.g., words and/or phrases that are highlighted with a color associated with what, who, when, where, how, and why), underlining, marking with appropriate symbols, etc. Factual detail information has a direct relationship to the purpose, i.e., action keywords, of the main idea, and thus its identification can be very useful.

In another aspect of the invention, signal words may be employed as a means to discover, while reading, and express, while writing, the purpose of the text. A listing of signal words is provided along with the related purpose that the signal words may identify. Signal words may also be identified with active consistent highlighting and other consistent unique identification techniques (underlining, marking with appropriate symbols, etc.) to represent the relationship between factual-information-details. This relationship then correlates to the purpose of the complete thematic main idea. (e.g., words and/or phrases that are highlighted with a color associated with question words of what, who, when, where, how, and why).

These and other aspects of the invention will be apparent from the following description and claims.

### BRIEF DESCRIPTION OF THE DRAWINGS

Aspects of the invention are described in conjunction with the following drawings in which like numerals reference like elements, and wherein:

FIG. 1 shows the contextual structure used in accordance with aspects of the invention and its various components;

FIG. 2 shows a list of signal words;

FIG. 3 shows a text that is used to illustrate techniques in accordance with aspects of the invention;

FIG. 4 shows the FIG. 3 text with the text portion including the main idea marked as associated with the main idea component of the contextual structure;

FIG. 5 shows a list of markings or symbols used to represent various components of the contextual structure;

FIG. 6 shows the FIG. 3 text with main idea keywords identified;

FIG. 7 shows the FIG. 3 text with major supporting details identified and keywords being pulled down to identify the supporting details;

FIG. 8 shows a flowchart of the main idea keywords and major supporting detail keywords in the FIG. 3 text;

FIG. 9 shows an outline of the main idea keywords and major supporting detail keywords in the FIG. 3 text;

FIG. 10 shows the FIG. 3 text with minor supporting details identified and keywords pulled down to identify the supporting details;

FIG. 11 shows the FIG. 3 text with subdetails identified;

FIG. 12 shows the FIG. 3 text and how action keywords and topic keywords in the main idea show a purpose of the main idea;

FIG. 13 shows the FIG. 3 text with signal words of various types identified;

FIGS. 14 and 15 show before and after student graphic representations of the contextual components and their relationship in a text when using marked flash cards to show relationships between the corresponding text;

FIG. 16 shows a puzzle used to express experience and understanding of text and its various components;

FIGS. 17-19 show a process for forming an outline and a flowchart that shows content within context using keywords;

FIG. 20 shows a text used to physically explain the meaning of prepositions in the text;

FIG. 21 shows a student-created flowchart before instruction regarding the function of prepositions;

FIG. 22 shows an example list of prepositions and their function;

FIG. 23 shows a flowchart having “empty” boxes for prepositions that are provided by the student;

FIG. 24 shows an outline of text with missing prepositions that are provided by the student;

FIGS. 25-28 are images used to illustrate the need to understand content within an overall context;

FIGS. 29A and 29B show a contextual structure and plot triangle for use in developing a story in text in accordance with an aspect of the invention.

### DETAILED DESCRIPTION

Aspects of the invention are described below with reference to one or more examples. However, it will be understood that aspects of the invention are not limited to the illustrative examples provided. For example, although color coding is widely used in the examples for uniquely identifying text as being related in some way to other text and/or to a particular component of the contextual structure (such as theme, topic, main idea, etc.), aspects of the invention may be used with other techniques for uniquely identifying text, such as through the use of symbols, written labels or other markings. Also, as used herein a “text” includes a verbal, aural, auditory or visual language construct, and thus is not limited to printed words.

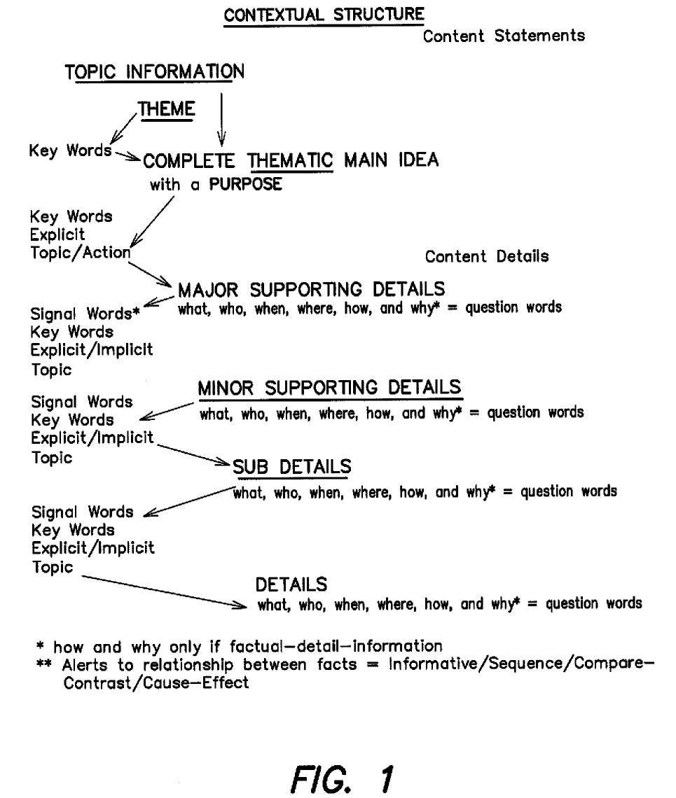

In one aspect of the invention, a contextual structure is employed to help a student understand the organization of portions of text and the relationship between the text portions. FIG. 1 shows a graphical representation of a contextual structure used in various aspects of the invention. The contextual structure includes a hierarchy of components that broadly fall into types, or categories, of keywords, signal words, question words, content statements and content details. Content statement components include topic, topic information, theme, and main idea components, with the main idea components having sub-components of complete thematic main idea and complete thematic main idea with purpose components. Content details components include major supporting details, minor supporting details, sub-details and details. Factual-detail-information is found primarily within content details Although FIG. 1 shows a complete contextual structure, aspects of the invention do not require the use of a complete contextual structure, but instead may be implemented using subsets of components of the contextual structure, such as a structure that includes the content statement components and one or more content details components only.

Definitions are provided for each of the contextual structure components below, and these definitions are reinforced to the student through various modes, such as an auditory mode where the student verbally identifies definitions for components of the contextual structure, a spatial mode where the student recreates the contextual structure (e.g., a graphical representation) from memory, and so on. These definitions along with various techniques described aid the student in identifying text portions that are related to a concept or contextual structure component. In one aspect of the invention, it is the combination and/or integration of modes employed in teaching and reinforcing various concepts with respect to the contextual structure that significantly improves student comprehension and retention suitable for later application and transfer to texts of different types. Note that keywords below may include single words or groups of words).

Contextual component definitions:

1) Topic—a focus of study. For example, a topic may be reflected in a textbook title, a chapter title, a section title, etc.

2) Topic information—relevant given information about the focus of study that should be previewed or understood before analysis or construction of the text. Topic information may be found in introduction sections for a textbook, units of a textbook, chapters, etc., particularly with respect to history or science subjects. For literature, topic information may be found in the summary on the back of the book, in a text introduction, in a third party summary or “note”, and so on.

3) Theme—the meaning, or “big picture” of the text; the theme is recurrent and applies to all people, places, nature and/or time. The theme may be unstated and may be a moral or lesson associated with the text.

4) Main idea—the most important message and purpose of the text. The main idea may incorporate topic information and theme keywords. Main idea action keywords convey the purpose of the text. The main idea may be located in various portions of a text such as a topic sentence of a paragraph, may be an answer to a question and/or may be unstated (i.e., must be inferred).

5) Major supporting details—these details explain or support the main idea; these details support the main idea and help students realize that the main idea is a true statement. Major supporting details can be found by using main idea keywords.

6) Minor supporting details—these details give more information about the major supporting details. These details can be found via keywords of the major supporting details.

7) Sub-details—these details give more information about the minor supporting details, These details can be found via keywords of the minor supporting details.

8) Details—these details give more information about the sub-details. These details can be found via keywords of the sub-details.

9) Topic keywords—keywords included in a main idea text portion that describe what topic information is developed in the related text portion.

10) Action keywords—keywords that identify what the topic(s) in the main idea text portion are doing.

11) Implicit/explicit keywords—Main idea keywords are explicit (i.e., expressly stated in the text). Supporting details keywords can be explicit or implicit (i.e., not expressly stated, but rather may be a synonym of an explicit keyword).

12) Signal words—these words identify the relationship between detail information included in content details. This relationship is the purpose of the content details with respect to the topic(s) being studied.

As mentioned above, in one aspect of the invention, one or more modes, e.g., visual, auditory, kinesthetic, experiential, associative and/or spatial modes with or without visual-auditory-motor integration, may be used for constructing or deconstructing text within an approach that uses a contextual structure for the text. These several modes and their integration with each other may be found particularly effective in teaching students how to analyze an existing text and/or in creating a text. Each of these modes forms an aspect of the invention as each mode (and/or its components, techniques or approaches) may be used alone or in any suitable combination with other modes.

For example, in a visual mode, text portions may be consistently visually marked regarding the contextual structure component(s) with which the text portions are associated. The text portions may be marked or otherwise visually identified so that each contextual structure component is visually distinguishable from other contextual structure components. For example, text portions related to topic information may be highlighted with a green color, marked with a box shape, annotated with a “TI” marking, etc., whereas text portions related to a main idea may be highlighted with a purple color, marked with a triangle shape, annotated with a “MI” marking, etc., and so on. As should be understood, such unique consistent marking of different contextual structure components may be made by at least one of highlighting, color marking, written annotation, symbols, or written language. In this way, a student is provided memory clues and able to readily identify those text portions that relate to specific contextual structure components, and identify relationships and other features of the text.

In an auditory mode, a student may verbally identify text portions that are related to one or more components of the contextual structure, e.g., to express knowledge and understanding that the text portions relate to a particular contextual structure component and why. Further, an instructor may verbalize feedback to the student regarding the use of the contextual structure as well as verbalize a process of use of the contextual structure to the student, e.g., verbalize how one might internally (while thinking and without talking) use the contextual structure to analyze a text. A student may also be required to verbalize definitions for each contextual structure component. By employing such techniques, some students, especially those that learn through verbal instruction or experience, may better learn and retain content knowledge as well as learn, retain and understand how to use the contextual structure approach.

In a kinesthetic mode, physical objects, such as pieces of paper, game pieces, index cards, etc., may be provided that are each visually marked to be associated with a corresponding contextual structure component. The physical objects may also include text portions that are respectively associated with the corresponding contextual structure component. For example, a text portion that is associated with topic information may be included on a piece of paper that is colored green and has a square shape, whereas a text portion associated with a main idea may be provided on a purple piece of paper that has a triangle shape, and so on. The physical objects may be manipulated, e.g., by the student and/or instructor, to represent relationships between the text portions on the physical objects. For example, pieces of paper with text portions for several contextual structure components may be organized on a desktop in a structural framework like that shown in FIG. 1, i.e., with text portions related to topic being positioned at a top region, text portions related to topic information positioned below topic, text portions related to theme located below topic information, and so on. Other organizational schemes are possible, such as flowchart arrangements, an outline format, and so on, as discussed in more detail below. Physical manipulation of the objects may aid students, especially those that learn best by touch, feel and movement, in understanding and retaining how the contextual structure may be used to analyze text.

In an associative mode, pictures, words or other representations may be verbally and/or visually identified with one or more portions of the contextual structure for a text, and the student may express a related experience and understanding. Physical objects, such as pieces of paper, game pieces, index cards, etc., may be provided for the student to represent associated experiences to knowledge and understanding of the contextual structure for a text. In another embodiment, the student may artistically create a representation of associated experiences to knowledge and understanding of the contextual structure for a text. The associative mode may be useful when aurally or visually presented words do not have meaning for the student. In such cases, associative approaches may be used to allow the student to associate an experience associated with the word so the word has meaning to the student.

In an experiential mode, physical objects that bear no resemblance to a topic at hand and/or that do bear a resemblance to a topic at hand may be manipulated to express a relationship and connection between the physical objects as parts, and as parts of a whole from content to detail, content details, question words, signal words, and/or a preposition framework. For example, a student may not understand that a main idea topic sentence is part of a paragraph, e.g., the student states that a main idea topic sentence is on a paragraph. Therefore, the student may be asked to put a pen on the desk or given a bowl of water and asked to put a small piece of wood on the water. Then, the student is asked to put a cut-up main idea sentence on a piece of paper on a paragraph. Through these types of experiential exercises, the student then realizes that a main idea topic sentence is part of a paragraph as content statements are part of the contextual structure.

In a spatial mode, a student may be required to create a hierarchical framework of the contextual structure, such as by copying the framework shown in FIG. 1 and/or recreating the contextual structure from memory. The student may then be asked to enter text portions from a text into the hierarchical framework so that the text portions are located in appropriate correspondence with a component of the contextual structure, e.g., words associated with a main idea are located near the main idea portion of the framework, and so on. Furthermore, the student may then be asked to fill-in missing text portions from a text represented into the hierarchical structural framework so that the text portions are in appropriate correspondence components of the contextual structure, e.g., words associated with a main idea are located near the main idea portion of the framework, and so on. In another set of examples, the location of keywords and other text portions may provide information regarding the relationship of various contextual structure components. For example, keywords in text may be identified to find and understand a relationship between components of the contextual structure, e.g., action keywords for a main idea can relate a purpose for nearby topic information, and thus illuminate the relationship between supporting details related to the main idea. Action keywords can also be identified in text to determine the purpose of a related thematic main idea.

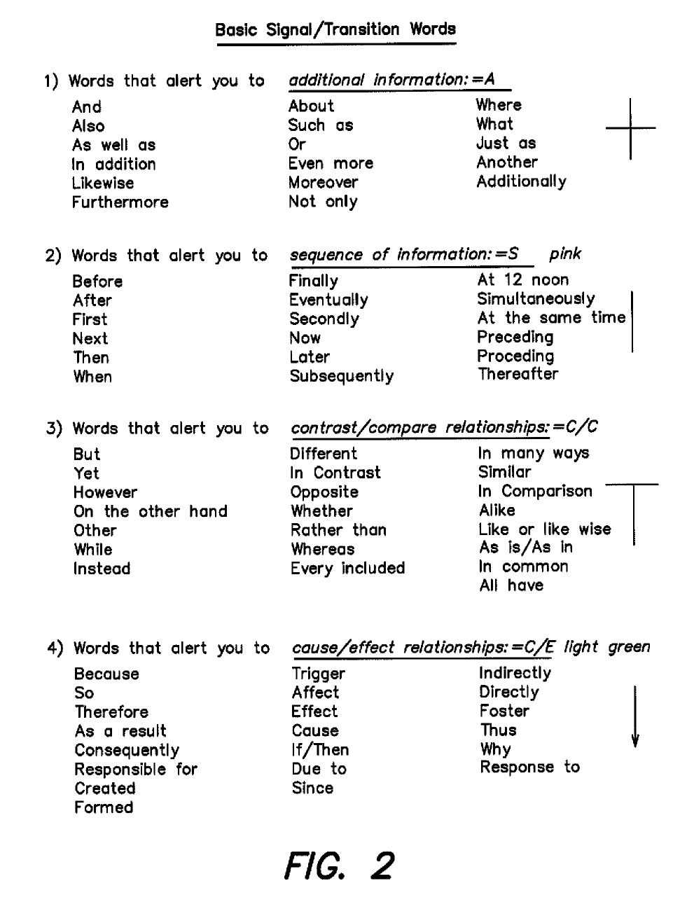

In another aspect of the invention, signal words can be located to find and understand a relationship between content components and their contextual purpose, i.e., the relationship between supporting details can be the purpose of factual-detail-information presented for a related main idea. FIG. 2 shows a non-exhaustive list of signal words that can be used to identify such relationships. Commonly, such signal words bind together factual details that answer question words of what, who, when, where, how and why, to the overall purpose of the text. Thus, in accordance with one aspect of the invention, text portions that answer such questions may be identified as being related to content details components of the contextual structure.

In another aspect of the invention, flowcharts, simultaneous flowcharts and outlines may be created to represent or evidence understanding of the components of the contextual structure and how they are connected to each other. Within presented words, students may need to visualize the overall structure of how the words connect before they can understand and learn. Flowcharts, simultaneous flowcharts, and outlines as graphic-organizers illustrate a student's understanding and knowledge. From student representation via graphic-organizers, instruction and feedback occur so that students can then represent or evidence correct knowledge and understanding.

In another aspect of the invention, integrated flowcharts or other graphic-organizers may be used to represent simultaneous and sequential information and the relationship between different types of information within a text, Student-created integrated flowcharts illustrate a student's ability to grasp simultaneous and sequential content information that is connected within a purposeful context. Within a text, there may be more than one theme and more than one thematic main idea with a purpose. Hence, a student must learn to differentiate between text portions that relate to different themes, and integrate the various text portions as they relate to each other, for example. Integrated flowcharts are instructional graphic organizers used to ensure student knowledge and understanding of differentiation and integration of simultaneous and sequential connected information within a text.

In another aspect of the invention, prepositions may be identified and the relationships they represent may be articulated. Sentences within a text may contain prepositions that represent the relationship between the prepositional objects and/or topics. Correct knowledge and understanding of a text is then dependent upon understanding the prepositions, as students must visualize how objects and/or topics connect to extract proper meaning. Identifying prepositions as grammatical components and then having students identify or draw a picture to represent the relationship fosters knowledge and understanding of the meaning of the text, and then how components of the text, represented as a contextual structure, connect to form an integrated whole text. A flowchart and/or outline may be missing appropriate prepositions that a student must provide to evidence understanding of the relationship between components of the contextual structure.

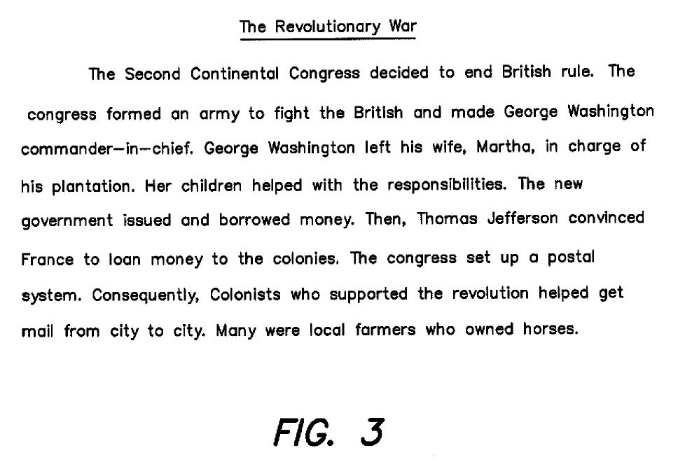

Some of the techniques and other aspects in accordance with the invention are described below in connection with a piece of example text shown in FIG. 3. However, it should be understood that aspects of the invention can be used with any suitable text (visual, aural or otherwise), and may be used to generate text, as when writing a story. A student generally learns best by operating in constructive, integrative phases, starting with the most basic concepts and then working up to more complicated and/or abstract techniques. In analyzing the sample text in FIG. 3, a constructive, integrative approach is likewise taken to the analysis.

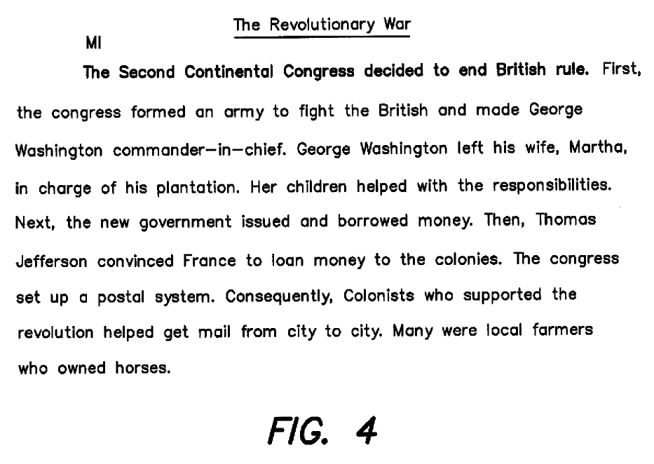

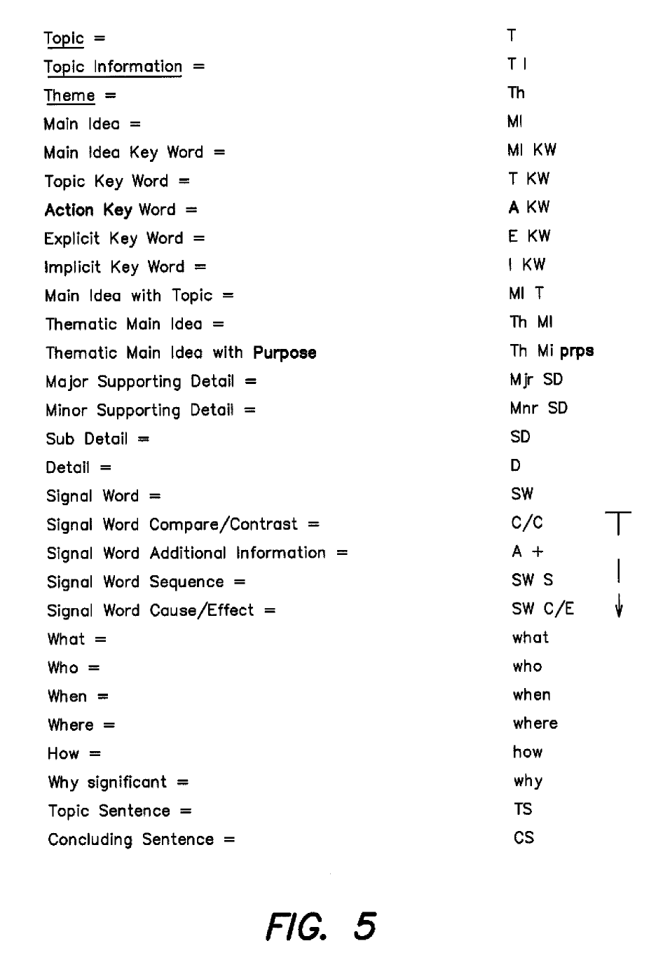

Identifying a main idea is typically a first step for the beginning student. As shown in FIG. 4, the sample text has been marked to identify those text portions that correspond to a main idea. In this example, those portions of text are bolded and marked with “MI”, but as mentioned above, any suitable marking may be used such as highlighting, other color coding, and so on. FIG. 5 shows a listing of markings for various contextual structure components that are used herein, but those of skill in the art will appreciate that these markings may be varied. The main idea is the most important message of the text, and generally contains enough information so that the rest of the sentences in the paragraph can prove the statement true. For example, the sentence, “The ball is over there” is a statement of information. The student may be asked: Does the sentence contain enough information so that you can prove it to be true or find the ball? The sentence, “The soccer ball is over there, across the hall in another room” is also a statement of information. Yet, the second sentence has enough information so that you know what kind of ball you are looking for and can find the ball, The main idea generally will not contain detail facts, but can be an answer to a question and is the topic sentence of a paragraph, which can be at the beginning, middle, or end of a paragraph.

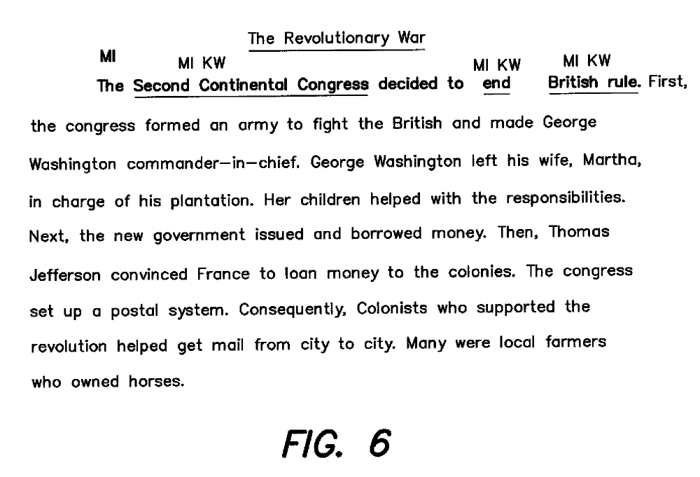

Next, as shown in FIG. 6, the sample text is marked to identify main idea keywords, In this example, the main idea keywords are underlined and marked with “MIKW,” but may be marked in other ways, e.g., may be circled words that are part of the main idea and marked “MI.” A student may be instructed that keywords exist, i.e., are explicit, for a main idea or topic sentence of a paragraph, and that the keywords are the most important words of the main idea, Also, when keywords are linked together, they convey the main idea. Keywords can be either a single word or a group of words. The reason why a group of words may be included in a keyword is so that a “whole picture” of what the words mean can be gleaned.

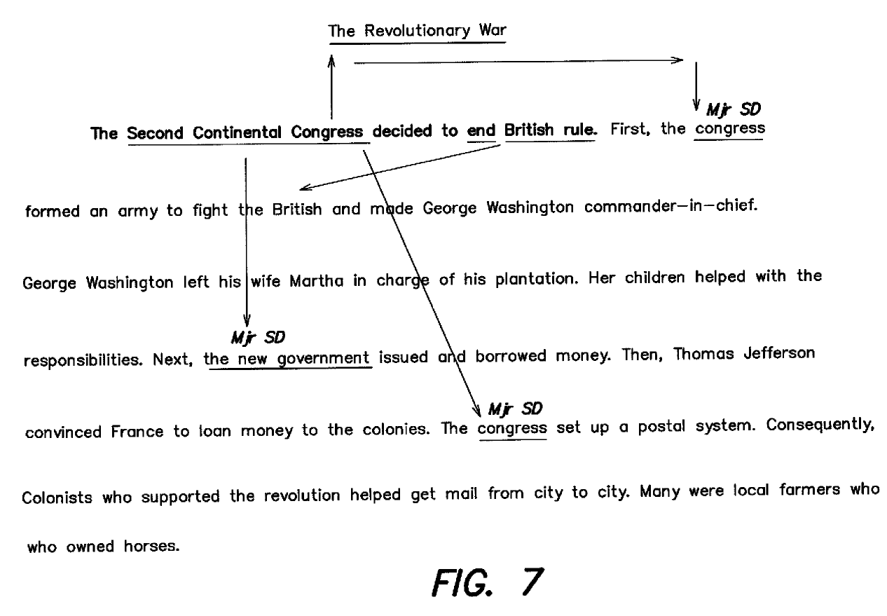

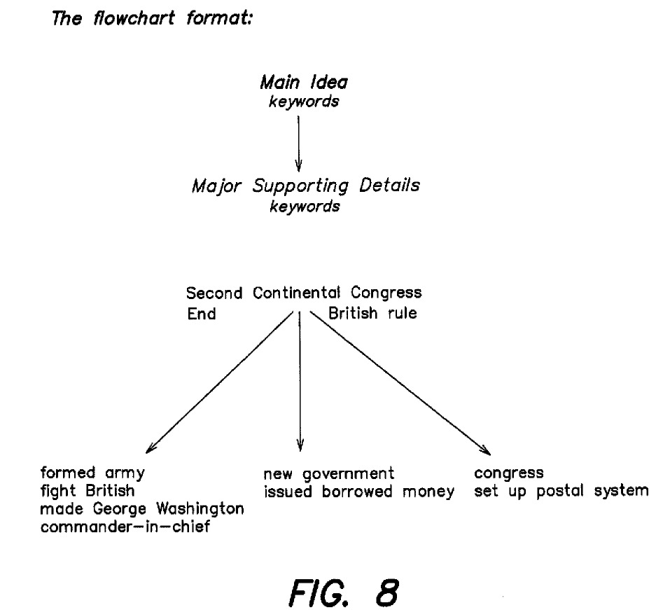

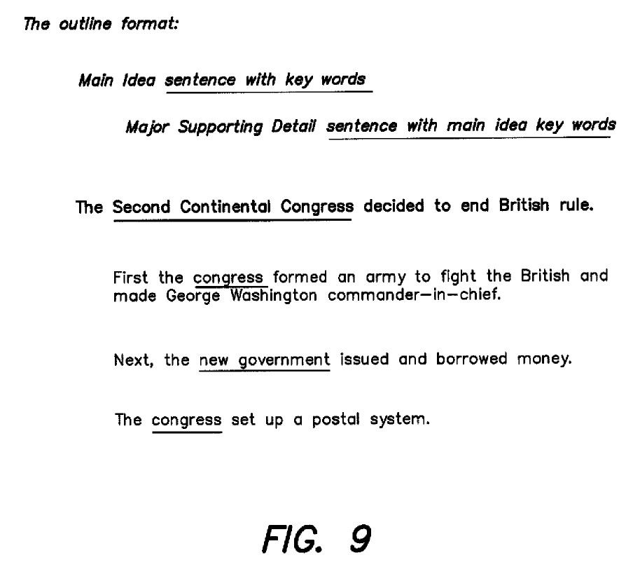

In an next step, the contextual structure component of content details, e.g., major supporting details, may be introduced. Major supporting details explain or support the main idea; they prove that the main idea is true, and therefore support the main idea. Major supporting details may themselves have keywords and can be found by using the keywords from the main idea, as shown in FIG. 7. In this example, major supporting details are marked with “Mjr SD.” FIGS. 8 and 9 show alternate ways to visualize and graphically represent a relationship between main idea and major supporting detail. FIG. 8 shows a flowchart format for the text in FIG. 7, whereas FIG. 9 shows an outline format for the text in FIG. 7.

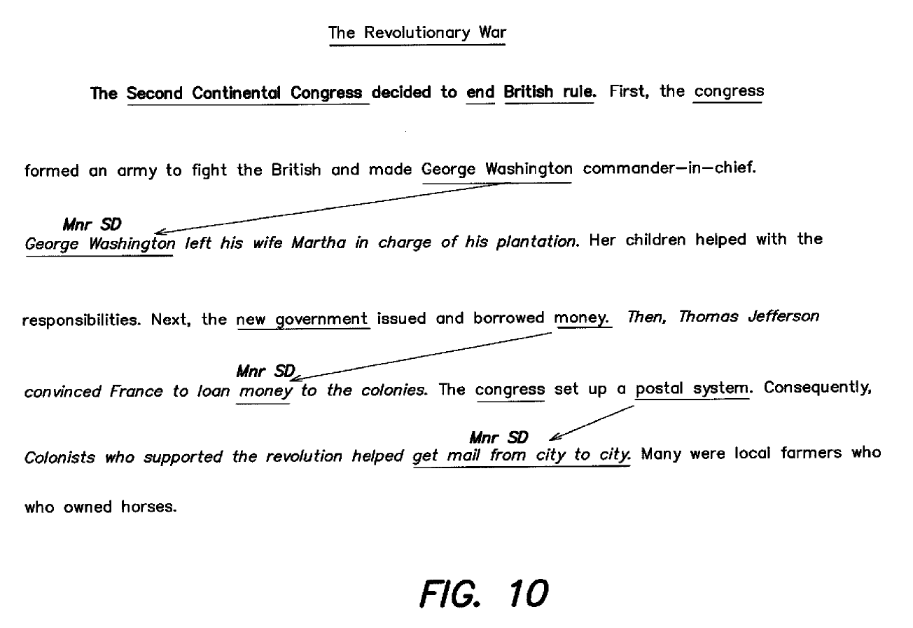

The components of minor supporting details and subdetails may be introduced next. The keywords from major supporting details may lead to relevant minor supporting details, which give more information about the keywords in the major supporting details. Information provided by the supporting details is developed in a sequential, logical flow, and minor supporting details keywords can be connected back to the main idea. FIG. 10 shows the sample text with minor supporting details marked “Mnr SD,” Of course, the relationship between main idea, major supporting details, and minor supporting details may be shown in graphical form, such as a flowchart format like that in FIG. 8 and/or an outline format like that in FIG. 9 with the minor supporting details falling below the major supporting details in the hierarchy (as shown in FIG. 1). Different graphical approaches may be taken that are best suited to the student's understanding and retention.

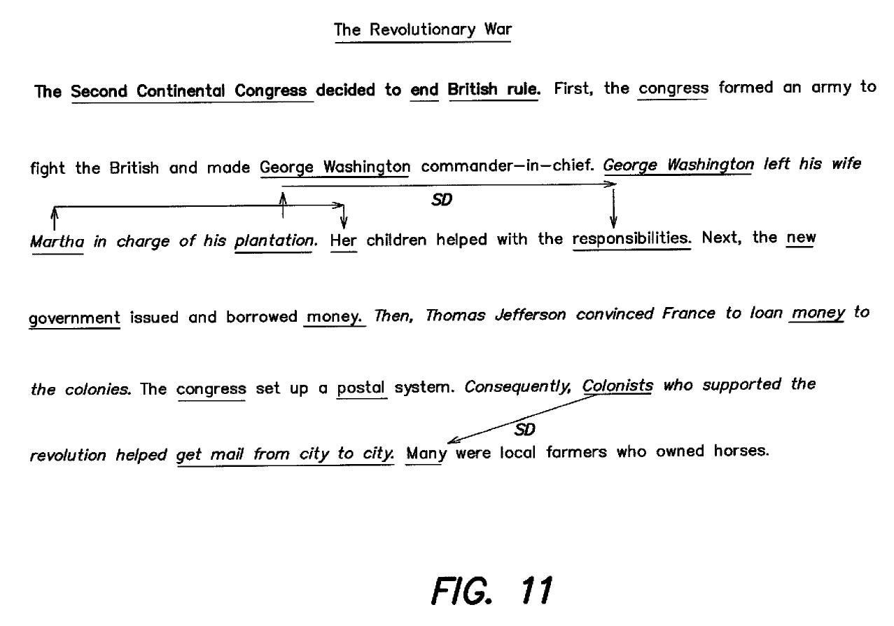

As for subdetails, the student may be instructed that finding subdetails can be a confusing process, Subdetails give more information about keywords in the minor supporting details and can be related back to the main idea. To make the identification of subdetails easier, it may help to break down the main idea keywords into topic key words. Next, the major and minor supporting details may be broken down into topic keywords as well, as shown underlined and italicized in FIG. 11. Next, keywords from the main idea and/or supporting details portions may be “pulled down” (i.e., identified in lower portions of the text) to the subdetail level. As shown in FIG. 11, pulling down of keywords may be done by drawing a connecting line (e.g., an arrow), thus showing the connection or relationship between components. Subdetail elements are marked with an “SD” (and in this case the font is changed)

Regarding details, keywords from the subdetails will lead you to the details, which provide more information about the keywords in the subdetails. Details are most often found in science texts and can be related back to the main idea and further develop information about the main idea. The information provided by details, like that for other detail content, is developed in a sequential logical flow. As mentioned above, the contextual structure used to analyze a text may not include all of the components shown in FIG. 1. For example, some texts simply may not include subdetails or details components.

Another component of the contextual structure, questions words, can be introduced to help find relevant factual-detail-information within the supporting details. For example, the student may be told that, when reading a textbook, apply the question words: What, Who, When, Where, How, Why, to each heading, and sub heading to help find the relevant factual-detail-information within the supporting details. When the answer to a question word is found, the answer (text portion) should be marked with the appropriate symbol, color, etc., to identify the contextual structure component associated with the text portion.

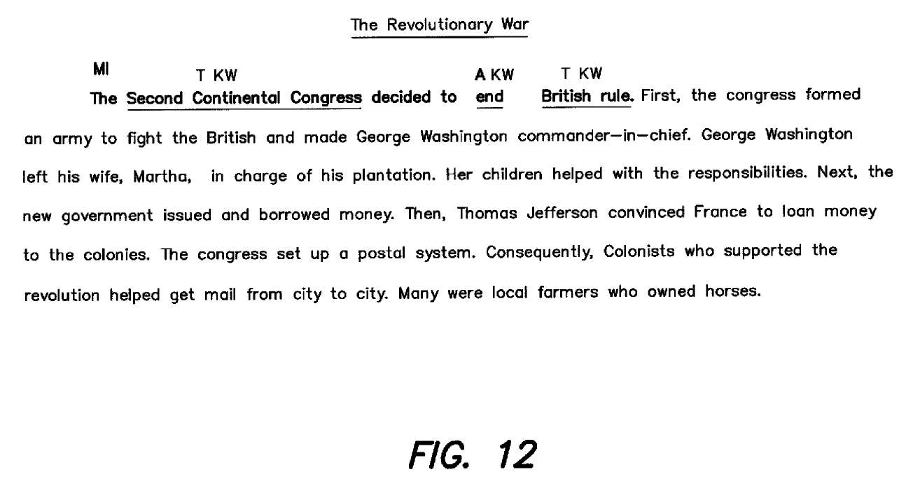

At a next level, the student may be introduced to the concept of topic, action keywords and purpose. As mentioned above, a topic is the focus of study, and may be a title of an article, text, chapter heading, etc. Generally, a student should know what the topic is before beginning to read. A main idea commonly will include both action keywords and topic keywords, i.e., main idea keywords can be broken down into topic or action keywords. Action key words alert us to what the topics are doing, i.e., the purpose of the topic information, and topic key words in a main idea tell us what topic information will be developed in the paragraph or other following text section. The student may be instructed: topic information cannot float around as if in the vacuum of space; instead, topic information must have a purpose. If there is no purpose to the main idea, then the supporting details developed in the paragraph have no connection, or relationship, and become random bits of content factual detail information. FIG. 12 shows a text portion with topic keywords marked “TKW” and action keywords marked “AKW”. In this case the action keyword “end” tells us the purpose of the Congress in this instance—to bring British rule to a stop.

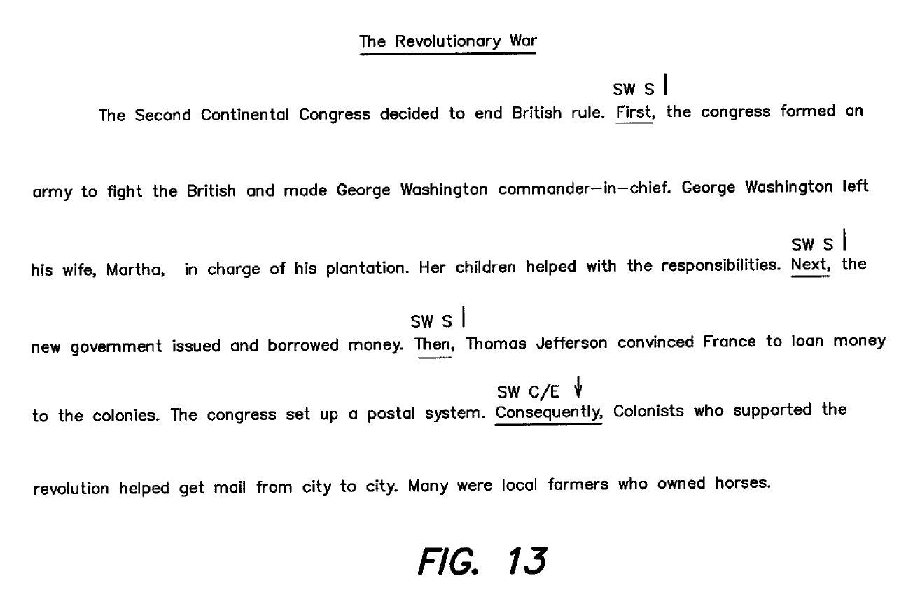

Signal words, another component of the contextual structure, are generally used to alert the reader to the relationship between the factual-detail-information within the content supporting details. FIG. 2 shows a list of signal words in one illustrative embodiment. Authors use certain words to help us discover what the relationship is between the content details so that they can develop the topics and purpose of the main idea. That relationship is the purpose of the factual-detail-information presented about the topics you are studying. FIG. 13 shows a sample text with signal words identified as “SW”.

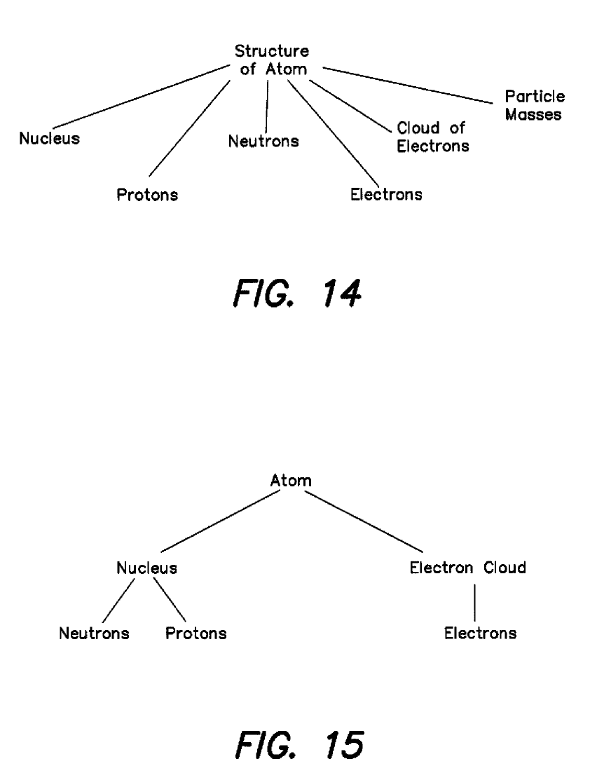

As discussed above, one technique to help a student understand relationships between components of the contextual structure is to place text portions on color coded or otherwise marked cards, and then have the student manipulate the cards to represent the relationships between text portions. In one particular circumstance, a student was initially incapable of creating a graphic illustrator to show comprehension of a particular text relating to the atom and its structure, even though the student had read and correctly identified contextual components of text. FIG. 14 shows the initial form of the graphic illustrator created by the student. Thereafter, student was asked to label content keywords within the text as follows:

| | |
|---|---|
| Atom | T and MI T KW |
| Nucleus | Mjr SD |
| Electron Cloud | Mjr SD |
| Neutrons | Mnr SD |
| Protons | Mnr SD |
| Electrons | Mnr SD |

Then, the student made flashcards that were colored so as to correspond with the contextual structure component for each keyword, and the corresponding keyword with abbreviation was written on the front of each card. A basic definition was written on the back of each card. The student reread text, manipulating cards while reading to represent comprehension of visual text. Upon rereading, the student was able to create an appropriate graphic representation of the various contextual components and their relationship, shown in FIG. 15.

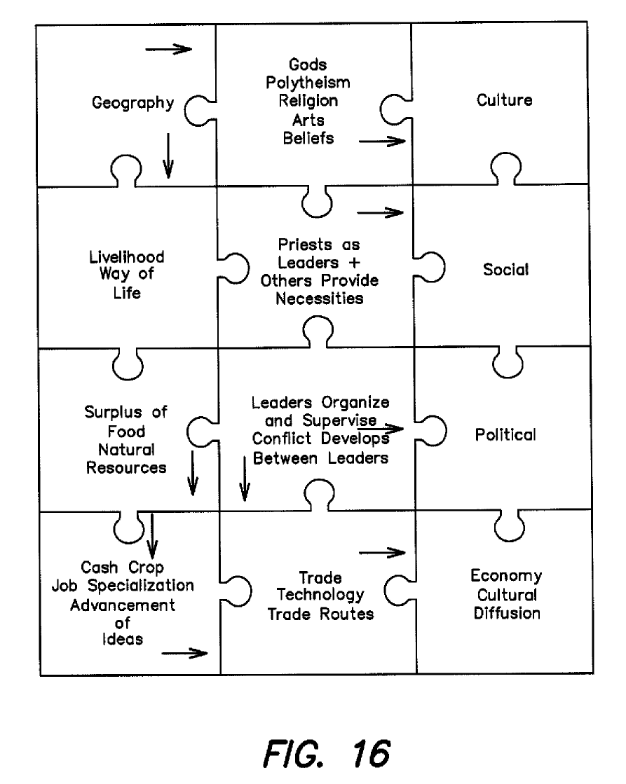

In another aspect of the invention, pictures, words or other representations may be created to express experience and understanding of text and its various components. For example, as shown in FIG. 16, a puzzle may be constructed that includes various words or phrases extracted from a text that are each associated with corresponding components of the contextual structure. The words and phrases may be arranged in the puzzle so that the student can understand the relationship between two words or phrases (i.e., the puzzle pieces fit) while also understanding that some words and phrases do not relate (i.e., the puzzle pieces do not fit together.) As will be understood by those of skill in the art, other associative techniques may be employed as suitable.

In another aspect of the invention, physical objects that bear no resemblance to a topic at hand may be manipulated to express relationship and connection between the physical objects as parts and as parts to a whole from content to detail, content details, question words, signal words, and/or a preposition framework. For example, the following is a breakdown of content material from a science textbook:

Water pollutants are mainly produced by households, agriculture, industry, mining, and other human activities.

Water Pollutants: Iron; Copper; Mercury; Benzene

In one instance, the student could not visualize that elements and chemicals made up water pollutants from presented visual language even though the student could find, mark, and graphically represent content of text. To help the student understand this concept, a container filled with potting soil and a live plant was used to facilitate visual language comprehension. First, the student saw and held the container. Second, different ingredients to make up the potting soil were on hand in marked labeled bags, i.e., Loam, Dirt, Peat moss, Water retention pellets. Third, an identical container and plant was given to the student with instructions to fill the container with equal mixtures of the above ingredients, plant the plant, and then water. Fourth, steps two and three were repeated, but salt was substituted for peat moss and weed killer was substituted for water retention pellets. Fifth, the student compared the two plants one week later. The plant from the fourth step above had died. Other such experiential mode techniques can be developed and used in accordance with aspects of the invention.

As also discussed above, in one aspect of the invention, action keywords may be used to identify the purpose of a thematic main idea. We know that topic keywords in a main idea relay what topic information will be developed in the paragraph, and that action keywords in a main idea tell us what the purpose of the topic information is. If there is no purpose to the main idea, then the supporting details developed in the paragraph have no connection, or relationship, and become random bits of content factual detail information. A student may be asked to read the following thematic main idea:
As a great leader of men, General George Washington was responsible for the colonial army's victory at Valley Forge.

What is the thematic key word? In this case, it is the word “leader.” What are the action keywords? In this case, the action keywords are “was responsible.” Therefore, what is the purpose of the above thematic main idea? The purpose is to prove that George Washington was responsible for the colonial army's victory at Valley Forge. Consequently, the remainder of the content detail sentences within the paragraph (not shown) must support or prove that George Washington's attitude and actions brought about victory. Also, signal words that represent cause/effect will then be used to demonstrate the cause/effect relationship between the details to support or prove the purpose of the thematic main idea. As can be seen in FIG. 2, “responsible” is a signal word that evidences cause/effect relationships. “Due to” is another signal word that shows cause/effect. For example, the sentence above may be followed by this sentence: “Due to General Washington's bravery and willingness to risk his own life during the battle, his troops enthusiastically carried out Washington's every order.” “Due to” signifies a cause/effect relationship and this relationship directly represents the purpose of the thematic main idea, “As a great leader of men, General George Washington was responsible for the colonial army's victory at Valley Forge.”

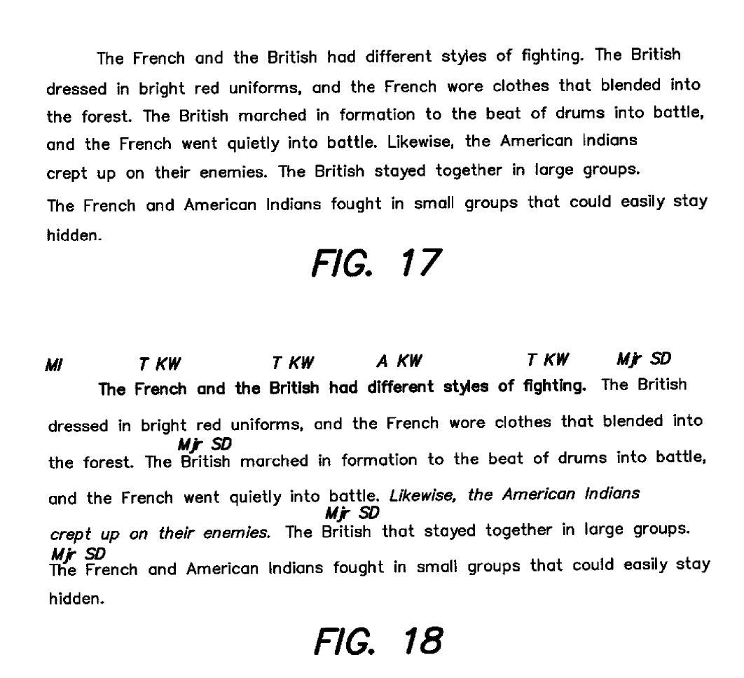

Another aspect of the invention involves the creation of flowcharts, simultaneous flowcharts, integrated flowcharts and outlines to represent understanding of the contextual structure. FIGS. 17-19 show an example of such a process, in this case for forming an outline and a flowchart that shows content within context using keywords. FIG. 17 shows the starting text, and FIG. 18 shows the text with contextual structure components identified. FIG. 19 shows steps for creating a flowchart, beginning with creating an outline, then identifying keywords in the outline, and lastly, assembling the appropriate keywords into a flowchart.

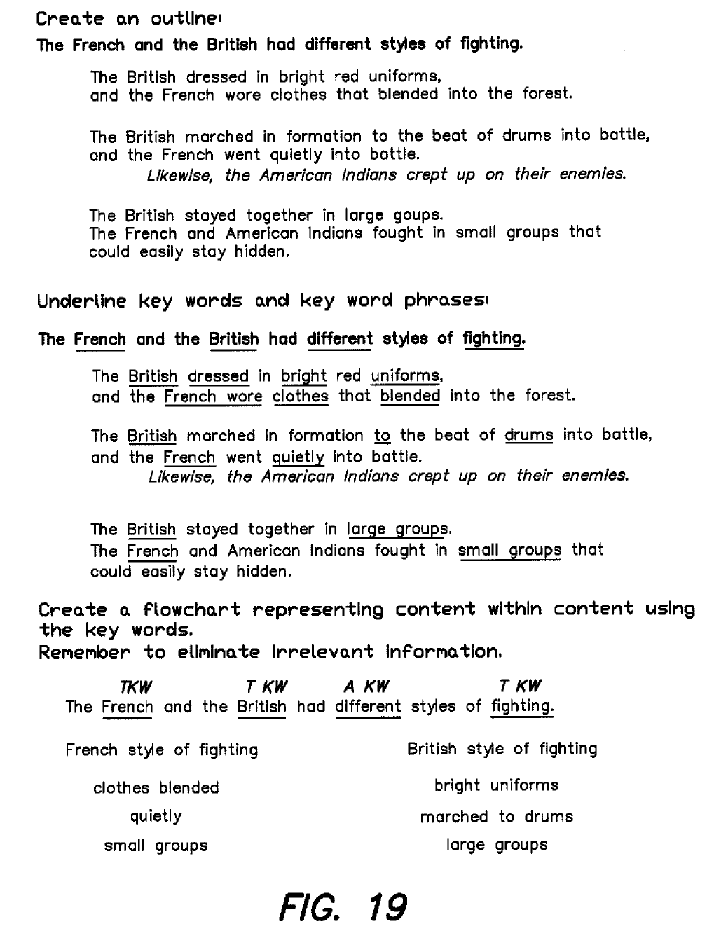

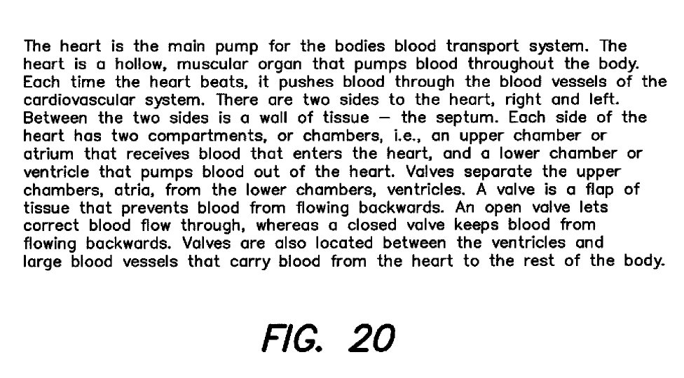

In another aspect of the invention, prepositions within information may be identified and an understanding of the relationship prepositions represent may be created, e.g., by manipulation of physical objects. FIG. 20 shows a text used to describe one such technique in an illustrative embodiment. In a specific case, a student could not visualize, and therefore not comprehend, where the septum and valves were located in a heart after reading a text similar to that in FIG. 20. The student could draw a labeled figure of the heart, but did not know where the septum or valves should go within the diagram. To help the student understand the meaning of the preposition “between”, highlighting markers (e.g., highlighting pens) were manipulated on a desktop. Two markers were placed parallel to each other on the desk, and a third was put in the middle of the two. The student was asked, and correctly responded that the third marker was in the middle. Again, two markers were placed parallel to each other and a third was put between the two. The student struggled with word retrieval and could not recall the word “between.” The student was provided with the word “between” and various manipulations with markers were performed by the instructor and student to represent “between.” Then, the student was asked if a football goes through or between goal posts and incorrectly responded through. A piece of paper was taken and a pen was pushed so that it passed partially through and left in the paper. Again, the goal post question was asked. The student correctly answered, but admitted it made no sense. Further manipulative exercises were performed with paper, pen, and markers. Eventually, the student was able to explain and demonstrate “between” using other manipulative objects. After returning to the text in FIG. 20, the student was able to correctly draw and label all heart structures, including the valves and septum.

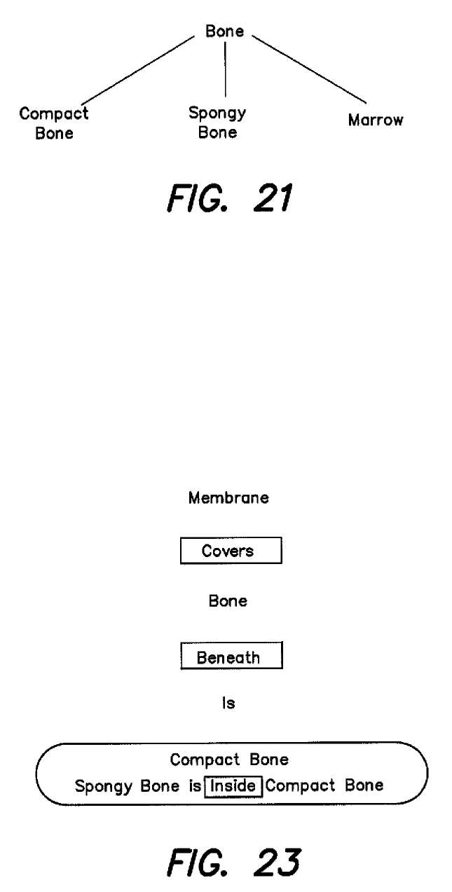

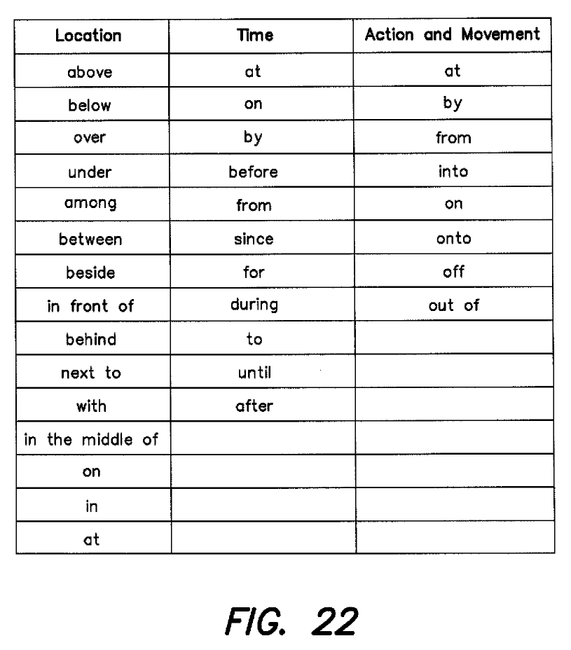

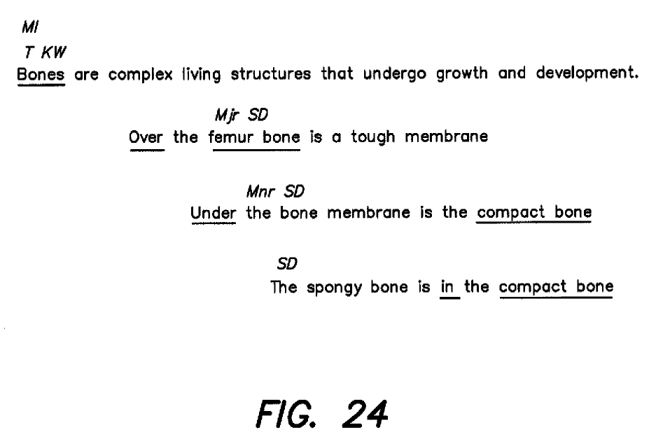

In another aspect of the invention, prepositions may be filled into empty spaces within a flowchart and/or outline to allow the student to demonstrate understanding of relationship between components of the contextual structure. For example, in one case, a student read a text describing the structure of bone, which generally includes an outer membrane covering compact (or cortical) bone. Beneath the cortical bone, is a spongy (or cancellous) bone. Also, there are some empty spaces in bone, and within those empty spaces is found marrow. After reading the text, the student created a flowchart like that shown in FIG. 21. However, the student did not understand the relationship between the various bone structures, e.g., which bone structure was found in, on, over, outside of, etc. another structure. A list of prepositions (see FIG. 22) was reviewed with the student. The student was then asked to re-read the text, color-coding and underlining prepositions. Thereafter, the student was given a graphic organizer of topic keywords shown in FIG. 23 and the student was asked to fill in the squares with appropriate prepositions (e.g., covers, beneath and inside were provided). The student was also provided an outline format representing the text portion with missing prepositions as shown in FIG. 24. In this exercise, the student could not use the same prepositions as used before, and the student filled in the prepositions “over,” “under” and “in.”

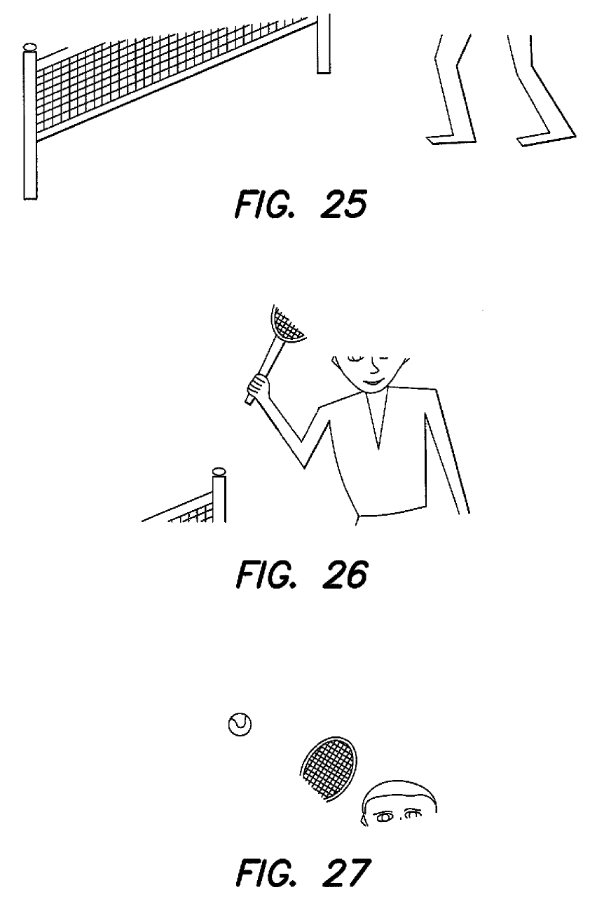

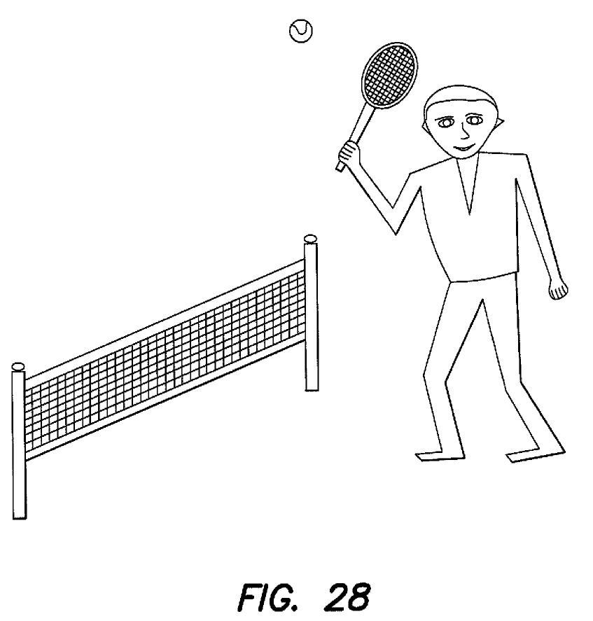

Some students cannot understand the function of text portions without viewing the text portions in an overall context. Learning how to determine content information within an overall context, while looking, hearing, or reading, is critical. What is equally important is what to do with the information once it has been identified. Organization, or chunking, of information found is a must if a pictorial, verbal, or visual presentation about information is to be in a cohesive, sequential, and, logical format so that others can understand what you want to convey. To illustrate this notion, a student may be asked to identify understandable information in each of FIGS. 25-27, which are fragments of a complete image shown in FIG. 28. The student may say they see feet and legs and a wall or net in FIG. 25, hands, arms and a face in FIG. 26, and a ball in FIG. 27. However, to understand what the components of each image are and how they relate to the overall meaning of the image, one must see them in complete context, i.e., in the assembled image of FIG. 28. The student can then be asked to discuss the topic of the FIG. 28 image (tennis), the theme (fan being had in a game), the main idea (the player is about to hit the ball), and details (arm is outstretched, both feet on the ground, etc.). Likewise, a story needs to provide a complete picture; details must fit together as a whole to convey the topic, main idea and theme.

Aspects of the invention may be applied to text of any length, complexity, content, etc. For example, a student was asked to infer information in order to predict what the article would be about from the title “Russia's Icy Defender”. The student underlined the title to mark it as associated with the contextual structure component of topic. Then, Russia was circled in blue, i.e., marked to associate Russia with answering a question for where. From Icy, the student inferred the word cold, and from that, inferred the answer winter for the question word of when. Regarding Defender, the student inferred the word war, and the theme of conflict. Here's how the student expressed this analysis: “This passage has something to do with Russia at war in the winter. We know that it's about Russia because it's in the title. Icy implies that it's in the winter, while defender implies they are at war. Defender also implies that they are being attacked. For Russia, there was not a person as a defender, their defender was winter itself.” Thus, having mastered the content and procedure of the contextual structure, the student was able to glean conceptual insight, as evidenced by above student-created independent work.

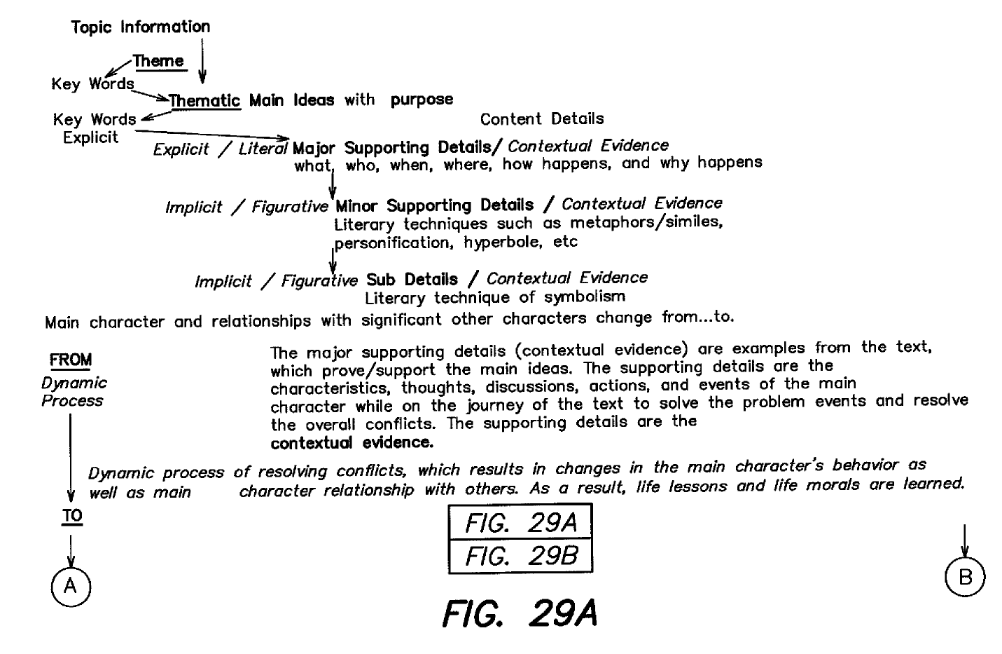

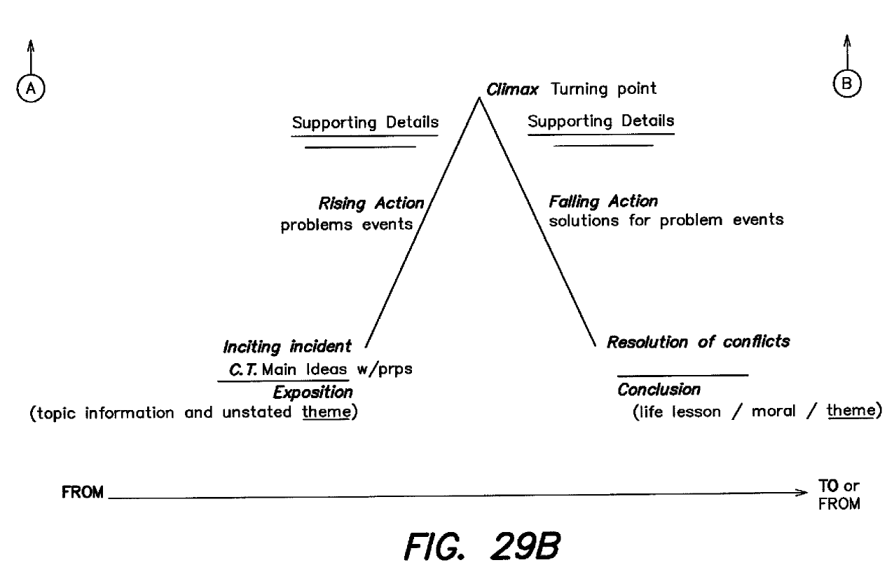

FIGS. 29A and 29B show another graphic illustrator that may be useful in instructing students when reading a literature text. At the top of FIG. 29A is a depiction of the contextual structure for use in literary development, while at the bottom of FIG. 29B is a structure referred to as a plot triangle which takes a story to be developed from beginning to end (left to right). At the beginning of the story, main ideas are introduced, as well as conflicts, and one or more themes. One or more problems arise (rising action) as the triangle ascends toward the apex. Supporting details should be provided by the writer here. At the climax or apex of the triangle, a turning point is reached, e.g., the main character may begin to solve problems or take action to resolve the problem events that arose previously. During the falling action, the solutions of the problems devised are described with suitable supporting detail, resulting in the resolution of the conflicts and conclusion. Following the constructive nature of the contextual structure, additional more developed plot triangles can be graphically illustrated. A single story may include two or more plot triangles, e.g., where there are several main characters or plot lines occurring at once. Other stories may be episodic in nature and have no clear beginning or end and be represented as a relatively flat plot line. However, each plot or subplot may be graphically represented from the basic contextual structure foundation.

Another technique in accordance with an aspect of the invention involves having a student select a single topic word, and then “take it to the top,” i.e., determine from the single topic word, a theme and then thematic main idea with a purpose. For example, take the topic word “botox.” From this topic word, the student can determine a theme (“youth”), and then write a thematic main idea with a purpose (“people who are afraid of growing and looking old use botox so that they can hold onto their youth as long as possible”). This promotes the fluent, flexible thought process involving reflective metacognitive skills that allow for transfer, adaptation, and problem solving. The contextual structure in accordance with the invention is designed to students can flexibly descend or ascend and become better fluent thinkers.

The above and other aspects of the invention will be appreciated from the detailed description and claims. It should be understood that although aspects of the invention have been described with reference to illustrative embodiments, aspects of the invention are not limited to the embodiments described. Also, aspects of the invention may be used alone, or in any suitable combination with other aspects of the invention.

1. A consistent, constructive method for constructing and/or deconstructing text including text portions that emphasizes automatic, procedural and conceptual knowledge within a sequential simultaneous model that reinforces attention-focus, short-term, working and long-term memory while allowing for application, transfer and adaptation, comprising:
employing visual, auditory, kinesthetic, experiential, associative and spatial modes with visual-auditory-motor integration for constructing or deconstructing text within an approach that uses a contextual structure for the text, the contextual structure including components of keywords, signal words, question words, content statements and content details, the keyword components including topic keywords, action keywords, explicit keywords and implicit keywords, the content statement components including topic, topic information, theme, main idea, complete thematic main idea, and complete thematic main idea with purpose components, and the content detail components including major supporting details, minor supporting details, sub-details and details containing factual-detail-information, the contextual structure components being connected by purpose and relationship of a context of the text;
each of the modes including:
for the visual mode,
consistently visually marking text portions related to the contextual structure components so that each contextual structure component is visually distinguishable from other contextual structure components, wherein the marking includes at least one of highlighting, color marking, written annotation, symbols, or written language;
for the auditory mode,
by a student, verbally identifying text portions related to components of the contextual structure to express knowledge and understanding;
by an instructor, verbalizing feedback to a student regarding use of the contextual structure and verbalizing self-internal-process of use of contextual structure to student;
by a student, verbally identifying definitions for each contextual structure component;
for the kinesthetic mode,
providing physical objects each visually marked to be associated with a contextual structure component,
providing text portions respectively associated with contextual structure components on correspondingly marked physical objects, and
manipulating the physical objects to represent relationships between the text portions on the physical objects;
for the associative mode,
verbally and/or visually identifying or creating representations, pictures, or words with one or more portions of the contextual structure for the text to express related experience and understanding;
for the experiential mode,
manipulating physical objects that bear no resemblance to topic at hand to express relationship and connection between the physical objects as parts and as parts to a whole from content to detail, content details, question words, signal words, and preposition framework;
manipulating physical objects that bear resemblance to topic at hand to express relationship and connection between the objects as parts and as parts to a whole from content and detail, content details, question words, signal words, and prepositions within the contextual structure;
a for the spatial mode,
physically creating a hierarchical framework of the contextual structure,
entering text portions from the text into the hierarchical framework such that the text portions are located in the framework so as to be properly associated with a corresponding contextual structure component,
identifying keywords in the text to find and understand a relationship between components of the contextual structure,
identifying action keywords in the text to determine the purpose of main idea(s) in the text,
identifying signal words to find and understand a relationship to between content components and contextual purpose;
identifying text portions that answer question words of what, who, when, where, how and why as being related to content details;
identifying relationships between contextual structure components and a purpose for the contextual structure components,
by the student, copying the contextual structure;
by the student, recreating the contextual structure from memory;
by the student, filling in empty spaces for the contextual structure;
drawing or creating unique symbols to represent relationship between and purpose of components of the contextual structure;
manipulating uniquely marked index cards to represent relationship and purpose;
creating flowcharts, simultaneous flowcharts and outlines to represent understanding of the contextual structure;
creating integrated flowcharts to represent information between different subject topics;
filling in empty spaces of flowcharts and outlines to represent critical understanding of relationship between components of the contextual structure;
identifying prepositions within information and creating understanding of relationship prepositions represent; and
filling in prepositions within a flowchart and outline to represent critical understanding of relationship between components of the contextual structure.

2. A method for constructing and/or deconstructing text including text portions, comprising:
employing visual, auditory, kinesthetic, experiential, associative and spatial modes for constructing or deconstructing text within an approach that uses a contextual structure for the text, the contextual structure including components of keywords, content statements and content details, the keyword components including topic keywords and action keywords, the content statement components including topic, topic information, theme, and main idea components, and the content detail components including supporting details components.

3. The method of claim 2, wherein the supporting details components includes major supporting details, minor supporting details, sub-details and details containing factual-detail-information.

4. The method of claim 2, wherein the step of employing the visual mode includes:
consistently visually marking text portions correspondingly related to the contextual structure components so that each contextual structure component is visually distinguishable from other contextual structure components, wherein the marking includes at least one of highlighting, color marking, written annotation, symbols, or written language.

5. The method of claim 2, wherein the step of employing the kinesthetic mode includes:
providing physical objects each visually marked to be associated with a contextual structure component;
providing text portions respectively associated with contextual structure components on correspondingly marked physical objects, and
manipulating the physical objects to represent relationships between the text portions on the physical objects.

6. The method of claim 2, wherein the step of employing the associative mode includes:
verbally and/or visually identifying or creating representations, pictures, or words with one or more components of the contextual structure for the text to express related experience and understanding of the corresponding contextual structure components.

7. The method of claim 2, wherein the step of employing the experiential mode includes:
manipulating physical objects that bear no resemblance to a topic at hand to express a relationship and connection between the physical objects as parts, and as parts to a whole, and to express how the relationship and connection between the physical objects illuminates corresponding relationship and connection between components of the contextual structure.

8. The method of claim 2, wherein the step of employing the spatial mode includes at least one of:
entering text portions from the text into the hierarchical framework such that the text portions are located in the framework so as to be properly associated with a corresponding contextual structure component;
identifying signal words to find and understand a relationship between content components and contextual purpose;
identifying text portions that answer question words of what, who, when, where, how and why as being related to content details;
recreating the contextual structure from memory and filling in empty spaces for the contextual structure; and
drawing or creating unique symbols to represent relationship between and purpose of components of the contextual structure.

9. A method for constructing or deconstructing text, comprising:
identifying text portions relating to the following components of a contextual structure: topic information, theme, main idea and supporting details; so that text portions of each type are visually distinct from text portions of other types; and
using the identified text portions for previewing, organizing and/or writing text that includes the text portions.

10. The method of claim 9, further comprising:
constructing a complete, readable text by assembling the visually distinct topic information, theme, main idea and supporting details text portions.

11. The method of claim 9, wherein the step of identifying text portions comprises:
marking a printed version of a complete text to visually distinctly identify the text portions relating to topic information, theme, main idea and supporting details.

12. The method of claim 9, wherein the step of identifying comprises:
providing a plurality of separate cards that each include at least one word and are visually identified as relating to topic information, theme, main idea or supporting details text types, the plurality of separate cards including at least two cards relating to each of the topic information, theme, main idea and supporting details text types; and
wherein the method further comprises:
randomly selecting cards from the plurality of cards, the randomly selected cards including at least one card relating to each of the topic information, theme, main idea and supporting details text types; and
generating a story using the words included in the randomly selected cards.

13. The method of claim 9, wherein the step of identifying comprises:
identifying text portions as related to a main idea if the text portion includes words that are related to both theme and topic text portions.

14. The method of claim 9, wherein the step of identifying comprises:
identifying text portions that are adjacent to words associated with topic information as being related to supporting details.

15. The method of claim 9, wherein the step of identifying comprises:
identifying text portions that answer questions of what, who, when, where, how and why as being related to supporting details.

16. The method of claim 9, further comprising:
organizing the identified text portions into a plot triangle arrangement.

17. A method for constructing or deconstructing text, comprising:
identifying topic keywords associated with a topic of the text so as to be visually distinguishable from other keywords;
identifying action keywords associated with action words in the text that describe actions for the topic keywords so as to be visually distinguishable from other keywords, an action keyword that describes an action for a topic keyword being a related action keyword for the corresponding topic keyword; and
determining at least one complete main idea of the text based on the topic and related action keywords.

18. The method of claim 17, wherein the step of determining includes:
identifying a text portion that includes both topic and related action keywords as being a main idea.

19. A method for constructing or deconstructing text, comprising:
identifying thematic keywords associated with a theme in text so as to be visually distinguishable from other keywords;
identifying topic keywords associated with a topic of the text so as to be visually distinguishable from other keywords; and
determining at least one complete main idea of the text based on the theme and topic keywords.

20. The method of claim 19, further comprising:
identifying action keywords associated with action words in the text that describe actions for the topic keywords, an action keyword that describes an action for a topic keyword being a related action keyword for the corresponding topic keyword;
wherein action keywords define a purpose for the at least one complete main idea.

21. A method for constructing or deconstructing text, comprising:
identifying text portions relating to the following types: topic information, theme, main idea and supporting details; so that text portions of each type are visually distinct from text portions of other types;
identifying action keywords associated with action words in the text that describe actions for the text portions related to topic information, theme and main idea so as to be visually distinguishable from text portions of other types; and
determining a relationship between text portions related to supporting details and text portions related to topic information, theme and main idea based on the action keyword.

22. A method for playing a game, comprising:
providing a plurality of separate cards that each include at least one word and are visually identified as relating to topic information, theme, main idea or supporting details text types, the plurality of separate cards including at least two cards relating to each of the topic information, theme, main idea and supporting details text types;
randomly selecting cards from the plurality of cards, the randomly selected cards including at least one card relating to each of the topic information, theme, main idea and supporting details text types; and
generating a story using the words included in the randomly selected cards.
